(19) United States
(12) Patent Application Publication
(10) Pub. No.: US 2014/0278834 A1
(43) Pub. Date: Sep. 18, 2014

(54) VOTING ON ACTIONS FOR AN EVENT

(71) Applicant: Armchair Sports Productions Inc., Simpsonville, SC (US)

(72) Inventors: David E. Lautz, New York, NY (US); Matthew Loughran, Simpsonville, SC (US); Joseph Whelan, New York, NY (US)

(73) Assignee: Armchair Sports Productions Inc., Simpsonville, SC (US)

(21) Appl. No.: 14/202,769

(22) Filed: Mar. 10, 2014

Related U.S. Application Data
(60) Provisional application No. 61/783,840, filed on Mar. 14, 2013.

(51) Int. Cl. G07C 13/00

(52) U.S. Cl. CPC G07C 13/00
USPC 705/12

(57) ABSTRACT

In general, the subject matter described in this disclosure can be embodied in methods, systems, and program products. A first computing system receives indications of multiple actions that a user of a second computing system specified as being candidates for performance during an event. The first computing system sends, for receipt by multiple computing devices, information that identifies the multiple actions, so as to cause the multiple computing devices to present the multiple actions. The first computing system receives, from each of at least a subset of the multiple computing devices, an indication of one of the multiple actions that a user of the respective computing device selected, from among the multiple actions, as being an action that the user of the respective computing device selects. The first computing system identifies a particular one of the multiple actions that received a greatest level of selections by the users.

### CROSS REFERENCE TO RELATED APPLICATIONS

This application claims the priority of benefit to U.S. Application No. 61/783,840 filed on Mar. 14, 2013. The prior application is incorporated herein in its entirety.

### TECHNICAL FIELD

This document generally relates to voting on actions for an event.

### BACKGROUND

Some events involve a series of decisions by a director of such events. For example, many of the decisions in a team sporting event are dictated by a coach or a manager of each team that is involved in the sporting event. Such actions by the coach or manager can involve selecting one of many possible offensive or defensive plays to perform at a certain time during the sporting event, or deciding which of many players on a team roster to use at the certain time during the sporting event.

### SUMMARY

This document describes techniques, methods, systems, and other mechanisms for voting on actions for an event.

As additional description to the implementations described below, the present disclosure describes the following embodiments.

Embodiment 1 is a computer-implemented method for permitting audience control over a sporting event. The method comprises receiving, by a first computing system and as having been sent by a second computing system, indications of multiple actions that a user of the second computing system specified as being candidates for performance by a team that is participating in a sporting event. The method comprises sending, by the first computing system and for receipt by multiple computing devices, information that identifies the multiple actions, so as to cause the multiple computing devices to present, to users of the multiple computing devices, the multiple actions as candidates for performance by the team. The method comprises receiving, by the first computing system and from each of at least a subset of the multiple computing devices, an indication of one of the multiple actions that a user of the respective computing device selected, from among the multiple actions, as being an action that the user of the respective computing device selects for performance by the team. The method comprises identifying, by the first computing system, a particular one of the multiple actions that received a greatest level of selections by the users of the at least subset of the multiple computing devices. The method comprises sending, by the first computing system and for receipt by the second computing system, an indication of the particular one of the multiple actions, so as to cause the team to be prompted to perform the particular one of the multiple actions.

Embodiment 2 is the computer-implemented method of embodiment 1, wherein: multiple members of the team athletically participate in the sporting event, and at least some of the users of the at least subset of the multiple computing devices are not located at a venue at which the members of the team are participating in the sporting event, and instead are watching the sporting event through a television broadcast or an internet broadcast.

Embodiment 3 is the computer-implemented method of embodiment 2, wherein the user of the second computing system is a coach of the team or another individual that is affiliated with the team and that is located at the venue during performance of the sporting event.

Embodiment 4 is a computer-implemented method. The method comprises receiving, by a computing device and as having been sent from a remote computing system, indications of multiple actions that have been specified as candidates for performance by a team that is participating in a sporting event. The method comprises concurrently displaying, by the computing device, multiple user interface elements that respectively identify the multiple actions that have been specified as candidates for performance by the team. The method comprises receiving, by the computing device, selection by a user of the computing device of one of the multiple user interface elements, the one of the multiple user interface elements identifying one of the multiple actions. The method comprises sending, by the computing device and for receipt by the remote computing system, an indication that the user selected the one of the multiple actions, so as to cause the computing system to determine which one of the multiple actions received a greatest level of selections by the user and other users of other computing devices to which the multiple actions were also displayed for selection.

Embodiment 5 is the computer-implemented method of embodiment 4, wherein the user of the computing device is viewing the sporting event or listening to the sporting event in person or through a television broadcast, a radio broadcast, or an internet broadcast.

Embodiment 6 is the computer-implemented method of embodiment 4, wherein an individual that is employed by management of the team and that is at a venue at which the sporting is being performed specified the multiple actions.

Embodiment 7 is the computer-implemented method of embodiment 4, wherein sending the indication that the user selected the one of the multiple actions further results in the computing system providing information that prompts the team to perform the one of the multiple actions that received the greatest level of selections by the user and the other users.

Embodiment 8 is the computer-implemented method of embodiment 4, further comprising presenting, by the computing device, an indication of a time limit during which selection of the multiple user interface elements is available, selection of the multiple user interface elements being unavailable after expiration of the time limit.

Embodiment 9 is the computer-implemented method of embodiment 4, wherein the computing device is configured to permit selection by the user of a single one of the multiple user interface elements, to the exclusion of selection by the user of more than one of the multiple user interface elements, in response to the concurrent display of the multiple user interface elements.

Embodiment 10 is the computer-implemented method of embodiment 4, further comprising displaying, by the computing device and concurrent with the concurrent display of the multiple user interface elements, a current score of each team that is participating in the sporting event.

Embodiment 11 is the computer-implemented method of embodiment 10, further comprising displaying, by the computing device and concurrent with the concurrent display of the multiple user interface elements, a time remaining until completion of the sporting event or a portion of the sporting event.

Embodiment 12 is the computer-implemented method of embodiment 4. The method further comprises identifying, by the computing device, that the user of the computing device is able to specify a plurality of actions that will be displayed for selection to the other users of the other computing devices. The method further comprises displaying, by the computing device, a plurality of user interface elements that identify a plurality of actions that the team is able to perform during the sporting event. The method further comprises receiving, by the computing device, selection by the user of a subset of the plurality of user interface elements that identify a subset of the plurality of actions that the user has specified as being a second set of candidate actions for performance by the team. The method further comprises sending, by the computing device and for receipt by the computing system, indications of the second set of candidate actions, so as to cause the computing system to provide the second set of candidate actions for selection by each of the other users.

Embodiment 13 is a computer-implemented method. The method comprises displaying, by a computing device, a plurality of user interface elements that identify a plurality of actions that a team is able to be performed during a sporting event. The method comprises receiving, by the computing device, selection by a user of the computing device of a subset of the plurality of graphical user interface elements so as to identify a subset of the plurality of actions that the user has specified as being candidates for performance by the team during the sporting event. The method comprises sending, by the computing device and for receipt by a computing system, indications of the subset of the plurality of actions, so as to cause the computing system to request that multiple other users each select at least one of the actions in the subset of actions for performance by the team. The method comprises receiving, by the computing device and as having been sent by the computing system, an indication of a particular one of the multiple actions that received a greatest level of selections by the multiple other users. The method comprises causing, by the computing device, a prompt that the team perform the highest-voted one of the multiple actions.

Embodiment 14 is the computer-implemented method of embodiment 13, wherein: the plurality of graphical user interface elements are displayed concurrently; and receiving the selection by the user of the subset of the plurality of the graphical user interface elements includes identifying that the user contacted portions of a touchscreen at which each of the plurality of graphical user interface elements was displayed.

Embodiment 15 is the computer-implemented method of embodiment 13. The method further comprises receiving, by the computing device, an indication that the user selected one of the actions in the subset of the plurality of actions as a default action, wherein the computing device is configured to prompt the team to perform the default action in response to multiple of the actions in the subset of actions being selected a same amount by the multiple other users or in response to multiple of the actions in the subset of actions being selected a quantity of times that is beneath a threshold level of selections.

Embodiment 16 is the computer-implemented method of embodiment 13, wherein causing the prompt that the team perform the highest-voted one of the multiple actions includes displaying, by the computing device, a graphical user interface element that identifies the particular one of the multiple actions as being the one of the multiple actions that received a greatest level of selections.

Embodiment 17 is a computer-implemented method. The method comprises receiving, by a first computing system and as having been sent by a second computing system, indications of multiple actions that a user of the second computing system specified as being candidates for performance during an event. The method comprises sending, by the first computing system and for receipt by multiple computing devices, information that identifies the multiple actions, so as to cause the multiple computing devices to present the multiple actions as candidates for performance during the event. The method comprises receiving, by the first computing system and from each of at least a subset of the multiple computing devices, an indication of one of the multiple actions that a user of the respective computing device selected, from among the multiple actions, as being an action that the user of the respective computing device selects for performance during the event. The method comprises identifying, by the first computing system, a particular one of the multiple actions that received a greatest level of selections by the users of the at least subset of the multiple computing devices.

Embodiment 18 is the computer-implemented method of embodiment 17, further comprising sending, by the first computing system and for receipt by the second computing system, an indication of the particular one of the multiple actions, so as to cause the event to include performance of the particular one of the multiple actions.

Particular implementations can, in certain instances, realize one or more of the following advantages. An event that is typically non-interactive for an audience of the event may become interactive and involve members of the audience in deciding which actions to perform during the event. The interactive nature of the event may increase audience loyalty and increase a size of the audience. A team may “crowdsource” a preferred course of action at a particular stage of an event in order to minimize the dependence on a coach making correct or incorrect decisions for the event. Audience members may establish a status due to the members selecting actions that cause positive results for one or more teams.

The details of one or more implementations are set forth in the accompanying drawings and the description below. Other features, objects, and advantages will be apparent from the description and drawings, and from the claims.

### DESCRIPTION OF DRAWINGS

FIG. 1 illustrates a conceptual flow of a voting process in which a team coordinator creates and submits decisions for voting.

FIG. 2 illustrates a conceptual flow of a voting process in which an audience member creates and submits decisions for voting.

FIG. 3 is a diagram of an example system that involves a server system and one or more client devices.

FIG. 4 illustrates a welcome and login display screen of a team coordinator application.

FIG. 5 illustrates a display screen of a team coordinator football application.

FIG. 6 illustrates a display screen of a team coordinator baseball application.

FIG. 7 illustrates a display screen of a team coordinator hockey application.

FIG. 8 illustrates a display screen of a team coordinator soccer application.

FIG. 9 illustrates a welcome and login display screen of an armchair coach application.

FIG. 10 illustrates an audience voting display screen of an armchair coach football application.

FIG. 11 illustrates an audience voting display screen of an armchair coach baseball application.

FIG. 12 illustrates an audience voting display screen of an armchair coach hockey application.

FIG. 13 illustrates an audience voting display screen of an armchair coach soccer application.

FIG. 14 illustrates a submit decision display screen of the armchair coach football application.

FIG. 15 illustrates a submit decision display screen of the armchair coach baseball application.

FIG. 16 illustrates a submit decision display screen of the armchair coach hockey application.

FIG. 17 illustrates a submit decision display screen of the armchair coach soccer application.

FIGS. 18A-E show a diagram of operations that are performed during the voting process.

FIG. 19 is a conceptual diagram of a system that may be used to implement the systems and methods described in this document.

FIG. 20 is a block diagram of computing devices that may be used to implement the systems and methods described in this document, as either a client or as a server or plurality of servers.

Like reference symbols in the various drawings indicate like elements.

### DETAILED DESCRIPTION

This document generally describes voting on which of multiple actions to perform at a particular decision point in an event, such as a sporting event. The voting process enables audience members that are watching or listening to a sporting event (either in person or remotely) to be able to participate in the sporting event in a meaningful manner by voting on game decisions throughout the event. A participating sports league and franchise may agree to abide by the voting results of game decisions.

The computing devices and systems described herein are used by at least two different types of users, referred to at times in this document as a team coordinator and an audience member. A team coordinator may be a coach or coordinator for a sports team which has agreed to use the team decision voting technology described herein to make at least some of the decisions during a sporting event. The team coordinator may be present at the sporting event and may use a software application (referred to occasionally herein as the “team coordinator application”) on a computing device to submit game decisions for voting by the community. The team coordinator application may notify the team coordinator of the consensus results for game decisions voted on by the community members, for example, by displaying a selected result of a game decision which has been voted on. The computing device on which the team coordinator application executes may be a desktop computer, a laptop, a tablet, or a smartphone, for example.

An audience member may be a person viewing a live team sporting event and using the team decision voting technology described herein to affect game decisions throughout the event. An audience member may be viewing or listening to the live sporting event either in person (e.g., at a venue at which the sporting event is taking place), through a television or radio broadcast, or through an internet broadcast. Multiple audience members may participate in each vote, and each participating audience member may submit game decisions using a software application on a computing device of each respective audience member. The software application is referred to occasionally herein as the “armchair coach application” (to be described subsequently), which may run on a device such as a computer, television, tablet, or smartphone.

As just mentioned, an application that executes on computing devices used by members of the audience is sometimes referred to herein as the armchair coach application. This application program may allow each member of the audience to vote on game decisions. The armchair coach application may also enable members of the audience to create and submit their own game decisions for voting by other audience members.

An overall conceptual flow of the team decision voting technology is described with respect to FIGS. 1 and 2. FIG. 1 shows an example in which the team coordinator provides the decision options and FIG. 2 shows an example in which an audience member provides the decision options.

A team coordinator may be a coach, offensive coordinator, or defensive coordinator that is at a live team sporting event observing the play on the field (at 100). A team coordinator may also be another staff member or representative (agent) of the team organization. Based on the team coordinator's observations, the team coordinator (either directly or by directing another user) may use the team coordinator application that is shown in FIG. 5 to create a game decision appropriate for the current play conditions (at 101). At 501, the team coordinator is able to select the decision type (e.g., Offensive Play). At 502-505, the team coordinator is able to select specific features of certain team actions (e.g., Offensive Formation, Run/Pass play, Enable choice for vote). After the team coordinator is satisfied with the decision and voting choices, the team coordinator may submit the decision for voting (at 506). At a confirmation step, the team coordinator may select a preferred choice that can be used as a tiebreaker vote because team coordinators may not be able to participate in normal voting (at 507). After final confirmation (at 508), the decision may be displayed in a voting status window as the application awaits voting results on the game decision.

Again referencing FIG. 1, after final confirmation of the game decision, the team coordinator application may submit the game decision to a computing system for voting (at 102). The computing system may assign a unique decision identifier to the new game decision to be voted on, and the game decision may be recorded in the statistics database. The computing system may set a voting expiration period for the game decision.

The computing system may transmit the game decision to computing devices at which participating audience members have logged in to participate in game decisions. The participating audience members may receive the game decision on the armchair coach application's voting display tab, as shown in FIG. 10 (at 1004). The game decision description may be displayed (at 1001) along with the voting choices (at 1002). The armchair coach application may also display scoreboard display information. This scoreboard display information may be updated to represent a current status of certain aspects of the sporting event (at 1000). After evaluating the voting choices provided for the game decision (at 1002), the audience member may vote his or her choice by pressing or otherwise selecting an entry (at 1003). At this point the audience member may complete voting on the game decision and the audience member's computing device may submit the vote.

Still referencing FIG. 1, the game decision may be submitted by the armchair coach application to the central voting authority (at 104). The central voting authority may queue all game decision votes received for a game decision until the voting timer has expired, upon which time a voting calculation and validation process may begin. All game decision votes received after the voting timer has expired may be discarded. The voting calculation may tally all eligible game decision votes, where the game decision result may include ranked majorities of the voting choices for the game decision (action receiving the 1st most votes, action receiving the 2nd most votes, action receiving the 3rd most votes, action receiving the 4th most votes).

Some game decisions may specify that only one vote can be selected by a user per game decision. Some game decisions, such as selecting a player roster, may involve multiple selections by each user. In any case, the calculated game decision result may contain ranked majorities for only the quantity of outcomes permitted by the specific game decision.

After voting calculation is complete, the results may be stored by the computing system in the statistics database, and voting validation may be performed. The voting may be based on quorum requirements. The quorum may be set by the system and may be defined as a percentage or absolute number of logged in users that actually vote on any specific game decision. If quorum is not met for a specific vote on a game decision, then the vote may not be valid, and the team coordinator's “tiebreaker” vote (FIG. 5, at 506) may be selected by the computing system as the game decision result for the game decision. At the conclusion of voting validation, the calculated game decision result may be be entered into the statistics database and the central voting authority may send the decision game result to the team coordinator application for execution (FIG. 1, at 105).

Referencing FIG. 5, upon receiving the game decision result, the status of the game decision may be updated on the team coordinator application's main display (at 508). Referencing FIG. 1 (at 106), the team coordinator may read the decision result and execute the directed action on the field of play (at 107). This may conclude the voting process from the perspective of the team coordinator entering a game decision for voting. The team coordinator application for baseball, hockey, and soccer can be referenced in FIGS. 6-8, respectively. Other examples of the armchair coach application for baseball, hockey, and soccer can be referenced in FIGS. 11-13, respectively. The functions of the applications may be combined into a single application that provides for generation of game decisions for each of multiple different sports or events. Similarly, the functions of the armchair coach applications for baseball, hockey, and soccer can be combined into a single application that permits voting on each of the multiple different sports or events.

The voting process that is depicted with reference to FIG. 2 may be similar, although the game decision options may be specified by an audience member that is using the armchair coach application. Referencing FIG. 2 (at 200), the audience member creates and submits a game decision, where the process would instead be described with respect to the armchair coach application FIG. 14 (at 1401-1404). After submission of the game decision in FIG. 2 (at 200), the process may be similar or identical to the process in which the team coordinator submits game decisions.

An example difference occurs when the central voting authority determines that a decision result is invalid because the decision result does not satisfy quorum requirements defined by the voting system. In this case, the game decision and result may be discarded, and the team coordinator application may not display the calculated game decision to the team coordinator. Rather, the team coordinator application may indicate that the team is to perform the default action that was selected by the team coordinator before submitting the decision for a vote. Also, the team coordinator application may indicate that a quorum was not met and that the voting system is not providing a decision result. The team coordinator may be able to select a play of his or her choice. If the game decision result is validated, then the result is sent to the team coordinator (FIG. 2, at 203), read by the team coordinator (at 204), and executed (at 205). Examples of user interfaces for the armchair coach application in baseball, hockey, and soccer can be referenced in FIGS. 15-17, respectively.

Referring now to FIG. 3, the central voting authority 300 may include a plurality of servers. The central voting authority 300 may be able to access the one or more accounting databases 302 to manage user profiles and authentication information. The one or more game decision databases 303 may contain game decision templates so that users may construct decisions in an efficient and correct manor. The one or more statistics and audit databases 304 may track voting statistics and user behaviors. A delayed broadcast feed server 301 may consolidate statistics information for broadcast to the media networks 310, over a private network 307. Access to the central voting authority by the armchair coach applications 308 may occur over a public network 305. Access to the central voting authority by the team coordinator application (at 309), may occur over a private network (at 306).

The operations of the event voting system will now be described with reference to the diagram of FIGS. 18A-E. The diagram shows operations that are performed by three different types of computing systems, a team computing system (e.g., the device at which the team coordinator application executes), a remote computing system (e.g., the computing devices that implement the central voting authority), and each of multiple audience computing devices (e.g., devices on which the armchair coach application executes).

At box 1802, the team computing system downloads an application program. The application program may be the team coordinator application program that is described above. The application program may be downloaded from an application program marketplace.

At box 1804, the team computing system receives user input that causes the team computing system to launch the application program. For example, a team coordinator, upon a baseball game starting, may turn on the team computing system and select an icon that is displayed on the device desktop and that results in the team computing system executing instructions that are specified by the application program.

At box 1806, the team computing system displays a user interface for creating a new set of actions or selecting a saved set of actions. For example, upon launching the application program, the team computing system may prompt the user to select one of multiple sports (e.g., baseball, hockey, football, and basketball) for which to generate voting decisions. After the user selects one of the sports, the user may be presented with an option to generate a new set of actions or select one of multiple saved sets of actions. As a result of the user providing input to view various saved sets of actions, the team computing system may display a list of twenty sets of actions. The sets of actions may include various labels, such as “Long pass plays,” “Fourth down plays,” and “Punt or go for it plays.”

As a result of the user providing input to create a new set of actions, the team computing system (at box 1806) may display a plurality of user interface elements for different actions, where the different actions are candidates to be performed by the sports team. For example, the team computing system may present the user interface that is shown in FIG. 5 (football), FIG. 6 (baseball), FIG. 7 (hockey), or FIG. 8 (soccer). Each of these user interfaces include a plurality of user interface elements that identify actions that are candidates to be performed by the sports team (e.g., the user interface element groupings 520, 620, 720, and 820). The team computing system may display the plurality of user interface elements concurrently and each of the plurality of user interface elements may identify an action that the team can perform during the sporting event. For example, each user interface element may include text that displays a name for the corresponding action or may include a diagram that shows how the corresponding action is to be performed.

At box 1808, the team computing system receives selection, by a user, of a subset of the plurality of user interface elements (and thus a subset of the plurality of actions). For example, the user of the team computing system may press his or her finger at regions of a touchscreen of the team computing system at which the subset of the plurality of user interface elements are displayed. With reference to FIG. 5, the user interface indicates (with check marks) that the user has selected the “Right Wing—Inside” interface element 522a, the “Split End—Short Pass” interface element 522b, the “Slot Left—Long Pass” interface element 522c, and the “Trick Play—Double Reverse” interface element 522d.

At box 1810, the team computing system receives selection by the user of a user interface element that causes the team computing system to specify an action that the user does not select. As an illustration, the user may select two plays that he or she would like to be included in a set of plays put up for a vote by the audience that is watching the sporting event, but the user does not want to specify two additional plays (e.g., due to time constraints before the play is set to begin). As such, the user may press a “computer picks play” interface element two times and the computer system may use algorithms to select two plays for inclusion in the selected set of plays.

After selecting the subset of the plurality of actions, the user may select the “Submit Decision for Vote” 524 interface element. The dialog box 526 may appear as a result. The dialog box 526 may display each of the actions that the user had previously selected, and may provide an ability for the user to select one of the selected actions as a “default” or “tiebreaker” action. As discussed later, the team computing system, or the remote computing system, may be configured so that the team is prompted to perform the default action if the audience vote is a tie between two of the actions, or if an insufficient number of individuals vote on a particular set of actions.

At box 1814, the team computing system sends, for receipt by the remote computing system, information that identifies the multiple actions that the user specified as being candidates for performance during the sporting event. For example, the team computing system may transmit, over the internet, numerical identifiers of the plays that the team coordinator selected using his tablet computer.

At box 1816, the remote computing system receives the indications of the multiple actions. For example, one or more computerized servers that include programmable computer processors may receive the numerical identifiers of the plays. The numerical identifiers may be transmitted over the internet.

The operations of boxes 1802 through 1814 describe a user of the team computing system using the team computing system to specify actions. The user of the team computing system may be an employee of a manager of the team (e.g., a coach of the team). Yet, an audience member may also be able to specify actions to be put up for a vote by the audience, as discussed with reference to boxes 1820 through 1832.

At box 1820, the audience computing device downloads an application program. The application program may be the armchair coach application program that is described above. The application program may be downloaded from the application program marketplace.

At box 1822, the audience computing device receives input from a user that causes the audience computing device to launch the application program. For example, an audience member may have turned on a television device to watch the baseball game. Wanting to participate in the performance of the baseball game, the audience member may select an icon on a desktop display of the audience computing device. As a result, the audience computing device may launch the armchair application program.

At box 1824, the audience computing device receives an indication that the user of the audience computing device is authorized to specify a set of actions that will be displayed to other users of the other computing devices for selection by the other users. The indications may be received from the remote computing system, and may have been initiated by the team coordinator authorizing the audience member to specify the set of actions (either by initiative of the team coordinator, or in response to a request from the audience member). In some examples, the indication is initiated by the remote computing system in response to the audience member submitting payment for the ability to specify the set of actions, or in response to the audience member receiving an award or threshold level of credits, as discussed in greater detail below.

At boxes 1826 and 1828, the audience computing device displays a plurality of user interface elements for a plurality of respective actions, and receives user selection of a subset of the actions, much as described with respect to boxes 1806 and 1808, except using an interface of the armchair coach application, such as one of those shown in FIG. 14 (football), FIG. 15 (baseball), FIG. 16 (hockey), or FIG. 17 (soccer).

At box 1830, once the user has selected the subset of the actions, the audience computing device receives an indication that the user selected one of the subset of actions as being the user's preference for operation by the team. In essence, the user votes on one of the user's own candidate actions. The user's vote may be included in the calculation of which action the community prefers.

At box 1832, the audience computing device sends the selected subset of the actions for receipt by the remote computing system, much like the operations at box 1814.

At box 1816, the remote computing system receives the indications of the multiple actions, as previously described.

At box 1838, the remote computing system queues multiple sets of actions. For example, the remote computing system may receive multiple sets of user-specified actions from the team computing system or one or more of the audience computing devices. The computing system may be configured to provide a single set of actions for voting with each play (e.g., with each football play), with each stoppage in action (e.g., with each whistle blow in a hockey game), or upon occurrence of a regular time interval (e.g., every 10 minutes during a soccer game).

At box 1840, the remote computing system sends, for receipt by each of multiple audience computing devices, information that identifies the multiple actions from a set of actions that is at a top of the queue. For example, the remote computing system may send information that identifies the four actions that are identified by the graphical user interface elements 522a-d of FIG. 5.

At box 1842, each of the multiple audience computing devices receives the information and, as a result, displays multiple user interface elements that respectively identify the multiple actions that have been specified as candidates for performance by the team. For example, an audience computing device may display the multiple user interface elements in the “audience voting” user interface that is shown in FIG. 10 (football), FIG. 11 (baseball), FIG. 12 (hockey), or FIG. 13 (soccer). User interface elements 1020a-d are examples of the multiple user interface elements. Each of the user interface elements 1020a-d include text that identifies the corresponding action and a diagram that identifies the corresponding action. The audience computing device may display the user interface elements 1020a-d concurrently.

At box 1848, the audience computing device may display information that identifies a current status of the event. For example, a user interface may display a current score of each team that is participating in the event, as shown in FIGS. 10-13. The user interface may also or alternatively show a time remaining until completion of the sporting event or a portion of the sporting event (e.g., a period, quarter, or half), as shown in FIGS. 10-13. These features may be displayed concurrently in the user interface with the graphical interface elements 1020a-d, for example, so that a user can take the current status of the event into account when selecting the user's preferred choice for an action. The information that identifies the current status of the event may represent the actual status of the event, as the event is being currently performed (e.g., as the sporting event is being athletically performed by members of the team on a field of play) with a momentary delay of a less than 30 seconds, 20 seconds, 10 seconds, or 5 seconds.

At box 1850, the audience computing device may display a countdown timer. For example, the audience computing device may display, concurrent with the display of the multiple user interface elements 1020a-d, an indication of a time limit during which selection of the multiple user interface elements is available, where selection of any one of the multiple user interface elements is not available after expiration of the time limit. In other words, should a user select one of the multiple user interface elements after expiration of the timer, the user's vote may not be transmitted for tallying by the remote computing system, or may not otherwise count. In some examples, the audience computing device removes the user interface elements 1020a-d from the display after expiration of the timer.

At box 1852, the audience computing device receives selection, by the user of the audience computing device, of one or more of the multiple user interface elements. For example, a user may contact a touchscreen of the audience computing device at a location at which one of the user interface elements 1020a-d is displayed in order to select the user interface element. In some examples, an application program executing on the audience computing device (e.g., the armchair coach application) may be configured so that a user is able to only select one of the multiple user interface elements. In other words, the user may be able to only vote for one play at a time. In some examples, a confirmation dialog box is not shown to the user, and the user's vote is cast as a result of the user contacting a displayed location of one of the user interface elements 1020a-d, without the user providing further user input before transmission of the user's vote to the remote computing system. In some examples, a user is able to select multiple actions by selecting multiple user interface elements. For example, the available actions may include substituting into a hockey game players that are available to participate in the next period of the hockey game, and the user may select six of players that that user would like to participate in the next period from a set of ten available players.

At box 1854, the audience computing device sends an indication of the action that the user selected. For example, the audience computing device may send a wireless communication for routing over the internet to the remote computing system. The wireless communication may specify a numerical value of the action that the user selected, to the exclusion of other of the actions that the user did not select. In examples in which the user is able to select multiple actions, the audience computing device may send multiple indications of the multiple actions that the user selected.

At box 1856, the remote computing system receives, as having been transmitted by the audience computing device, an indication of the action that the user of the audience computing device selected (e.g., by selecting the corresponding user interface element).

The operations of boxes 1842 through 1854 may occur for multiple audience computing devices, and thus the remote computing system may receive selected actions from each of the audience computing devices at which a corresponding user selected an action (e.g., at least a subset of the audience computing devices to which the information described with respect to box 1840 was sent). The remote computing system may have instituted a countdown timer upon sending, to each of the audience computing devices, the information that identifies the multiple actions (box 1840). Upon expiration of the countdown timer, the remote computing system may no longer tally votes received from audience computing devices, whether or not the remote computing system receives the votes. Alternatively, upon expiration of the countdown timer, the remote computing system may deny permission for any remaining audience computing devices to transmit indications of user-selected actions.

At box 1864, the remote computing system determines a ranked order of the selected actions. For example, the remote computing system may determine a particular one of the multiple actions that received a greatest level of selections by the users of the audience computing devices, along with those actions that received a second-most level of actions, a third-most level of actions, etc. In other words, the remote computing system may determine a first-place action, a second-place action, a third-place action, and a fourth-place action.

In some examples, the remote computing system weights more heavily votes by some users of the audience computing devices than votes by other users of the audience computing devices. As discussed in greater detail below, users can be awarded points, for example, based on their previous selections being correct or the same as the team coordinator's default vote, or based at least in part solely upon a user's participation level regardless of a number of correct plays selected by the user. Users with a high level of points may see a multiplier effect with their selected actions, whereby their votes may count a multiple of a typical user's vote (e.g., a vote of 1.8 versus 1.0).

At box 1866, the remote computing system determines whether a satisfactory level of user selections of actions has been received. For example the remote computing system may determine whether the remote computing system has received a threshold level of indications of selected actions. The threshold level may be an absolute number of votes or a percentage of audience computing devices that are participating in the sporting event. For example, the remote computing system may determine whether a quorum of the audience computing devices that are participating in the sporting event have sent in a vote. For example, if less than 10% of the devices vote, the remote computing system may render the vote void, and may send an indication that the team implement the default action. An audience computing device may be identified as participating in the event if the device is in communication with the remote computing system so as to display the multiple actions that are candidates for performance by the team.

At box 1868, the remote computing system determines whether the two highest-ranked selected actions have been selected a same number of times. For example, the computing system may determine whether there has been a tie for first place. If so, the remote computing system may send an indication that the default action be implemented. If the default action is not one of the actions that has tied for first place, the remote computing system may perform another type of tie-breaking process to determine which of the tied actions the team should be prompted to perform.

At box 1870, the team computing system receives an indication that the default action should be implemented. For example, as a result of the remote computing system determining that a satisfactory level of selected actions has not been received (box 1866) or that two actions have tied for first place (box 1868), the remote computing system may send, for receipt by the team computing system, the indication that the default action is to be implemented. The indication may specify the default action (e.g., the indication may include an alphanumerical identifier for the default action rather than an alphanumerical identifier for another one of the multiple actions). The indication may be a command that specifies that the team computing system is to perform the default action, wherein the command may not specify which of the multiple actions is the default action and the team computing system may retrieve the default action from memory.

At box 1874, as a result of the remote computing system determining that a satisfactory level of selected actions has been received, and determining that there has been no tie, the remote computing system sends, for receipt by the team computing system, an indication of at least the highest-ranked action. For example, in scenarios in which the team decision has been configured to generate a single action, the remote computing system may send the single highest-ranked action for receipt by the team computing system. In other scenarios in which the team decision has been configured to generate multiple actions (e.g., which six of ten players should fill a roster), the remote computing system may send indications of the multiple actions. The transmission to the team computing system may include a designation of which action received the most votes. The transmission may include the vote totals and the ranking may be determined by the team computing system.

At box 1876, the team computing system receives the indication of the at least highest-ranked action as having been sent by the remote computing system.

At box 1878, the team computing system displays an indication of the action to be performed by the team, which prompts the team to perform the action. For example, the team computing system may display a graphical user interface element 530 that indicates which of the multiple actions the team is to perform. The team computing system may indicate a percentage or number of audience members that voted for the action, and a name of the action. As a result of viewing the graphical user interface element 530, the user of the team computing system may instruct members of the team to perform the action, or may request that another individual instruct the members of the team to perform the action. Either way, the team is prompted to perform the action. As discussed earlier, the team may have agreed to be bound by actions that are selected by the system.

The prompt may be displayed by a computing device that is different than a computing device at which a user specified the multiple actions, both devices being part of the team computing system. For example, the coach's assistant may specify the multiple actions using a first tablet device, and a result of the voting process may be transmitted to a smartphone that is held by the coach.

In some implementations, the results of the voting process (e.g., an indication of the action that received the most votes) are presented by the team computing system before presentation by the audience computing devices. For example, the team computing system may present the indication of the action that received the most votes, prompting the team to perform the action that received the most votes. After the team's performance of the action (e.g., after the team has begun performing the action or after the team has finished performing the action), the remote computing system may transmit, for receipt by each of the audience computing devices, an indication of which action received the most votes, so as to cause each of the audience computing devices to display an indication of such action. The remote computing system may receive a communication that indicates when the action has been performed, and receipt of this communication may trigger the transmission of the voting result for receipt by the audience computing devices. Television broadcasts and other internet broadcasts may similarly delay any display or presentation of information that indicates the action that received the most votes until the action has been performed by the team.

At box 1884, the remote computing system calculates and stores statistical information regarding user selections. The remote computing system may store such information in the decisions and statistics databases that are discussed with reference to FIG. 1. The statistical information may include, for each user that has an account with which the user is able to log into the armchair coach application, (i) a level with which the user selects the most-highly voted action (e.g., a number of times that the user has selected an action that ends up being implemented by the team, and a proportion of this number to all user selections), (ii) results of those actions that the user voted on and that were implemented by the team, and how favorable those results were (e.g., an average number of yards gained in a football game when the user selects the play that the team performed), and (iii) a level with which the user selects the default action (e.g., a number of times that the user has voted with the team coordinator, and a proportion of this number to all user selections).

At box 1886, the remote computing system generates user recognition information based on the statistical information. For example, upon the user selecting the most-highly voted action a certain number of times, or upon the user ranking within a threshold level of users for selecting the most-highly voted action (e.g., the user is in the top 10% of users when it comes to selecting the action that is ultimately performed by the team), the user may be given an award that is publicly displayed through use of the armchair coach application by other users. The remote computing system may additionally or alternatively provide the user with credits. The credits may be used to rank the user with respect to other users that are also awarded credits. The credits may also be used by the user to purchase special features, such as an ability to specify a set of actions for voting by the community of users (e.g., as described with respect to boxes 1824 through 1832). The credits may also affect the value of the user's vote (e.g., the user's selection of a particular action may count a multiple of another user that has a lower credit total).

At box 1888, the remote computing system sends an indication of the statistical information or an indication of the recognition information to an audience computing device.

At box 1890, an audience computing device receives the indication of the statistical information or the indication of the recognition information, and displays the statistical information or the recognition information. For example, the audience computing device may display the user's ranking, or an image that identifies a user award, as discussed above. The audience computing device may also display an indication of a number of times that the user has selected the most-highly voted action, or numbers or other types of identifiers that identify the above-described statistical information.

In some implementations, the team computing system may include multiple devices that work together and that execute multiple respective instances of the team coordinator application, for example, so that an offensive coordinator for a football team can generate options for offensive plays, and so that a defensive coordinator for the football team can generate options for defensive plays, during the same game.

In some implementations, the remote computing system receives user-specification of multiple actions and the audience votes on which of the multiple actions the users of the audience believe the team will perform, but the team is not bound to perform a highest-voted one of the multiple actions. Rather, the team is bound by agreement to perform one of the multiple actions, and the system may essentially record statistical information that identifies how well members of the audience can guess what action the team will perform.

The above description often refers to the audience computing device as a single device, but it should be understood that there may be multiple audience computing devices that act in a similar or identical manner. The devices may perform the above-described operations simultaneously or substantially simultaneously (e.g., thousands of audience computing devices may perform the operations of boxes 1842 though 1854 within a fifteen second window during which voting is open).

The voting technology described herein may be used with sporting events other than baseball, hockey, football, and basketball. For example, the voting technology may be used to guide the actions of one or more players of other sporting events including, but not limited to, bowling, pool, cricket, chess, checkers, curling, and golf. In some implementations the voting technology may be used to influence the actions during a non-sporting event including, but not limited to, an entertainment program (e.g., resulting in an audience controlled “choose your own adventure” televised or internet broadcast skit).

Referring now to FIG. 19, a conceptual diagram of a system that may be used to implement the systems and methods described in this document is illustrated. In the system, mobile computing device 1910 can wirelessly communicate with base station 1940, which can provide the mobile computing device wireless access to numerous hosted services 1960 through a network 1950.

In this illustration, the mobile computing device 1910 is depicted as a handheld mobile telephone (e.g., a smartphone, or an application telephone) that includes a touchscreen display device 1912 for presenting content to a user of the mobile computing device 1910 and receiving touch-based user inputs. Other visual, tactile, and auditory output components may also be provided (e.g., LED lights, a vibrating mechanism for tactile output, or a speaker for providing tonal, voice-generated, or recorded output), as may various different input components (e.g., keyboard 1914, physical buttons, trackballs, accelerometers, gyroscopes, and magnetometers).

Example visual output mechanism in the form of display device 1912 may take the form of a display with resistive or capacitive touch capabilities. The display device may be for displaying video, graphics, images, and text, and for coordinating user touch input locations with the location of displayed information so that the device 1910 can associate user contact at a location of a displayed item with the item. The mobile computing device 1910 may also take alternative forms, including as a laptop computer, a tablet or slate computer, a personal digital assistant, an embedded system (e.g., a car navigation system), a desktop personal computer, or a computerized workstation.

An example mechanism for receiving user-input includes keyboard 1914, which may be a full qwerty keyboard or a traditional keypad that includes keys for the digits ‘0-9’, ‘*’, and ‘#.’ The keyboard 1914 receives input when a user physically contacts or depresses a keyboard key. User manipulation of a trackball 1916 or interaction with a track pad enables the user to supply directional and rate of movement information to the mobile computing device 1910 (e.g., to manipulate a position of a cursor on the display device 1912).

The mobile computing device 1910 may be able to determine a position of physical contact with the touchscreen display device 1912 (e.g., a position of contact by a finger or a stylus). Using the touchscreen 1912, various “virtual” input mechanisms may be produced, where a user interacts with a graphical user interface element depicted on the touchscreen 1912 by contacting the graphical user interface element. An example of a “virtual” input mechanism is a “software keyboard,” where a keyboard is displayed on the touchscreen and a user selects keys by pressing a region of the touchscreen 1912 that corresponds to each key.

The mobile computing device 1910 may include mechanical or touch sensitive buttons 1918a-d. Additionally, the mobile computing device may include buttons for adjusting volume output by the one or more speakers 1920, and a button for turning the mobile computing device on or off. A microphone 1922 allows the mobile computing device 1910 to convert audible sounds into an electrical signal that may be digitally encoded and stored in computer-readable memory, or transmitted to another computing device. The mobile computing device 1910 may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. Example operating systems include ANDROID, CHROME, IOS, MAC OS X, WINDOWS 7, WINDOWS PHONE 7, SYMBIAN, BLACKBERRY, WEBOS, a variety of UNIX operating systems; or a proprietary operating system for computerized devices. The operating system may provide a platform for the execution of application programs that facilitate interaction between the computing device and a user.

The mobile computing device 1910 may present a graphical user interface with the touchscreen 1912. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interface element may invoke a pre-defined action by the mobile computing device. In some examples, selectable graphical interface elements further or alternatively correspond to a button on the keyboard 1904. User-selection of the button may invoke the pre-defined action.

In some examples, the operating system provides a “desktop” graphical user interface that is displayed after turning on the mobile computing device 1910, after activating the mobile computing device 1910 from a sleep state, after “unlocking” the mobile computing device 1910, or after receiving user-selection of the “home” button 1918c. The desktop graphical user interface may display several graphical interface elements that, when selected, invoke corresponding application programs. An invoked application program may present a graphical interface that replaces the desktop graphical user interface until the application program terminates or is hidden from view.

User-input may influence an executing sequence of mobile computing device 1910 operations. For example, a single-action user input (e.g., a single tap of the touchscreen, swipe across the touchscreen, contact with a button, or combination of these occurring at a same time) may invoke an operation that changes a display of the user interface. Without the user-input, the user interface may not have changed at a particular time. For example, a multi-touch user input with the touchscreen 1912 may invoke a mapping application to “zoom-in” on a location, even though the mapping application may have by default zoomed-in after several seconds.

The desktop graphical interface can also display “widgets.” A widget is one or more graphical interface elements that are associated with an application program that is executing, and that display on the desktop content controlled by the executing application program. A widget's application program may launch as the mobile device turns on. Further, a widget may not take focus of the full display. Instead, a widget may only “own” a small portion of the desktop, displaying content and receiving touchscreen user-input within the portion of the desktop.

The mobile computing device 1910 may include one or more location-identification mechanisms. A location-identification mechanism may include a collection of hardware and software that provides the operating system and application programs an estimate of the mobile device's geographical position. A location-identification mechanism may employ satellite-based positioning techniques, base station transmitting antenna identification, multiple base station triangulation, internet access point IP location determinations, inferential identification of a user's position based on search engine queries, and user-supplied identification of location (e.g., by receiving user a “check in” to a location).

The mobile computing device 1910 may include other applications, computing sub-systems, and hardware. A call handling unit may receive an indication of an incoming telephone call and provide a user the capability to answer the incoming telephone call. A media player may allow a user to listen to music or play movies that are stored in local memory of the mobile computing device 1910. The mobile device 1910 may include a digital camera sensor, and corresponding image and video capture and editing software. An internet browser may enable the user to view content from a web page by typing in an addresses corresponding to the web page or selecting a link to the web page.

The mobile computing device 1910 may include an antenna to wirelessly communicate information with the base station 1940. The base station 1940 may be one of many base stations in a collection of base stations (e.g., a mobile telephone cellular network) that enables the mobile computing device 1910 to maintain communication with a network 1950 as the mobile computing device is geographically moved. The computing device 1910 may alternatively or additionally communicate with the network 1950 through a Wi-Fi router or a wired connection (e.g., ETHERNET, USB, or FIREWIRE). The computing device 1910 may also wirelessly communicate with other computing devices using BLUETOOTH protocols, or may employ an ad-hoc wireless network.

A service provider that operates the network of base stations may connect the mobile computing device 1910 to the network 1950 to enable communication between the mobile computing device 1910 and other computing systems that provide services 1960. Although the services 1960 may be provided over different networks (e.g., the service provider's internal network, the Public Switched Telephone Network, and the Internet), network 1950 is illustrated as a single network. The service provider may operate a server system 1952 that routes information packets and voice data between the mobile computing device 1910 and computing systems associated with the services 1960.

The network 1950 may connect the mobile computing device 1910 to the Public Switched Telephone Network (PSTN) 1962 in order to establish voice or fax communication between the mobile computing device 1910 and another computing device. For example, the service provider server system 1952 may receive an indication from the PSTN 1962 of an incoming call for the mobile computing device 1910. Conversely, the mobile computing device 1910 may send a communication to the service provider server system 1952 initiating a telephone call using a telephone number that is associated with a device accessible through the PSTN 1962.

The network 1950 may connect the mobile computing device 1910 with a Voice over Internet Protocol (VoIP) service 1964 that routes voice communications over an IP network, as opposed to the PSTN. For example, a user of the mobile computing device 1910 may invoke a VoIP application and initiate a call using the program. The service provider server system 1952 may forward voice data from the call to a VoIP service, which may route the call over the internet to a corresponding computing device, potentially using the PSTN for a final leg of the connection.

An application store 1966 may provide a user of the mobile computing device 1910 the ability to browse a list of remotely stored application programs that the user may download over the network 1950 and install on the mobile computing device 1910. The application store 1966 may serve as a repository of applications developed by third-party application developers. An application program that is installed on the mobile computing device 1910 may be able to communicate over the network 1950 with server systems that are designated for the application program. For example, a VoIP application program may be downloaded from the Application Store 1966, enabling the user to communicate with the VoIP service 1964.

The mobile computing device 1910 may access content on the internet 1968 through network 1950. For example, a user of the mobile computing device 1910 may invoke a web browser application that requests data from remote computing devices that are accessible at designated universal resource locations. In various examples, some of the services 1960 are accessible over the internet.

The mobile computing device may communicate with a personal computer 1970. For example, the personal computer 1970 may be the home computer for a user of the mobile computing device 1910. Thus, the user may be able to stream media from his personal computer 1970. The user may also view the file structure of his personal computer 1970, and transmit selected documents between the computerized devices.

A voice recognition service 1972 may receive voice communication data recorded with the mobile computing device's microphone 1922, and translate the voice communication into corresponding textual data. In some examples, the translated text is provided to a search engine as a web query, and responsive search engine search results are transmitted to the mobile computing device 1910.

The mobile computing device 1910 may communicate with a social network 1974. The social network may include numerous members, some of which have agreed to be related as acquaintances. Application programs on the mobile computing device 1910 may access the social network 1974 to retrieve information based on the acquaintances of the user of the mobile computing device. For example, an “address book” application program may retrieve telephone numbers for the user's acquaintances. In various examples, content may be delivered to the mobile computing device 1910 based on social network distances from the user to other members in a social network graph of members and connecting relationships. For example, advertisement and news article content may be selected for the user based on a level of interaction with such content by members that are “close” to the user (e.g., members that are “friends” or “friends of friends”).

The mobile computing device 1910 may access a personal set of contacts 1976 through network 1950. Each contact may identify an individual and include information about that individual (e.g., a phone number, an email address, and a birthday). Because the set of contacts is hosted remotely to the mobile computing device 1910, the user may access and maintain the contacts 1976 across several devices as a common set of contacts.

The mobile computing device 1910 may access cloud-based application programs 1978. Cloud-computing provides application programs (e.g., a word processor or an email program) that are hosted remotely from the mobile computing device 1910, and may be accessed by the device 1910 using a web browser or a dedicated program. Example cloud-based application programs include GOOGLE DOCS word processor and spreadsheet service, GOOGLE GMAIL webmail service, and PICASA picture manager.

Mapping service 1980 can provide the mobile computing device 1910 with street maps, route planning information, and satellite images. An example mapping service is GOOGLE MAPS. The mapping service 1980 may also receive queries and return location-specific results. For example, the mobile computing device 1910 may send an estimated location of the mobile computing device and a user-entered query for “pizza places” to the mapping service 1980. The mapping service 1980 may return a street map with “markers” superimposed on the map that identify geographical locations of nearby “pizza places.”

Turn-by-turn service 1982 may provide the mobile computing device 1910 with turn-by-turn directions to a user-supplied destination. For example, the turn-by-turn service 1982 may stream to device 1910 a street-level view of an estimated location of the device, along with data for providing audio commands and superimposing arrows that direct a user of the device 1910 to the destination.

Various forms of streaming media 1984 may be requested by the mobile computing device 1910. For example, computing device 1910 may request a stream for a pre-recorded video file, a live television program, or a live radio program. Example services that provide streaming media include YOUTUBE and PANDORA.

A micro-blogging service 1986 may receive from the mobile computing device 1910 a user-input post that does not identify recipients of the post. The micro-blogging service 1986 may disseminate the post to other members of the micro-blogging service 1986 that agreed to subscribe to the user.

A search engine 1988 may receive user-entered textual or verbal queries from the mobile computing device 1910, determine a set of internet-accessible documents that are responsive to the query, and provide to the device 1910 information to display a list of search results for the responsive documents. In examples where a verbal query is received, the voice recognition service 1972 may translate the received audio into a textual query that is sent to the search engine.

These and other services may be implemented in a server system 1990. A server system may be a combination of hardware and software that provides a service or a set of services. For example, a set of physically separate and networked computerized devices may operate together as a logical server system unit to handle the operations necessary to offer a service to hundreds of computing devices. A server system is also referred to herein as a computing system.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

“Determining” by a computing system can include the computing system requesting that another device perform the determination and supply the results to the computing system. Moreover, “displaying” or “presenting” by a computing system can include the computing system sending data for causing another device to display or present the referenced information.

FIG. 20 is a block diagram of computing devices 2000, 2050 that may be used to implement the systems and methods described in this document, as either a client or as a server or plurality of servers. Computing device 2000 is intended to represent various forms of digital computers, such as laptops, desktops, workstations, personal digital assistants, servers, blade servers, mainframes, and other appropriate computers. Computing device 2050 is intended to represent various forms of mobile devices, such as personal digital assistants, cellular telephones, smartphones, and other similar computing devices. The components shown here, their connections and relationships, and their functions, are meant to be examples only, and are not meant to limit implementations described and/or claimed in this document.

Computing device 2000 includes a processor 2002, memory 2004, a storage device 2006, a high-speed interface 2008 connecting to memory 2004 and high-speed expansion ports 2010, and a low speed interface 2012 connecting to low speed bus 2014 and storage device 2006. Each of the components 2002, 2004, 2006, 2008, 2010, and 2012, are interconnected using various busses, and may be mounted on a common motherboard or in other manners as appropriate. The processor 2002 can process instructions for execution within the computing device 2000, including instructions stored in the memory 2004 or on the storage device 2006 to display graphical information for a GUI on an external input/output device, such as display 2016 coupled to high-speed interface 2008. In other implementations, multiple processors and/or multiple buses may be used, as appropriate, along with multiple memories and types of memory. Also, multiple computing devices 2000 may be connected, with each device providing portions of the necessary operations (e.g., as a server bank, a group of blade servers, or a multi-processor system).

The memory 2004 stores information within the computing device 2000. In one implementation, the memory 2004 is a volatile memory unit or units. In another implementation, the memory 2004 is a non-volatile memory unit or units. The memory 2004 may also be another form of computer-readable medium, such as a magnetic or optical disk.

The storage device 2006 is capable of providing mass storage for the computing device 2000. In one implementation, the storage device 2006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 2004, the storage device 2006, or memory on processor 2002.

The high-speed controller 2008 manages bandwidth-intensive operations for the computing device 2000, while the low speed controller 2012 manages lower bandwidth-intensive operations. Such allocation of functions is an example only. In one implementation, the high-speed controller 2008 is coupled to memory 2004, display 2016 (e.g., through a graphics processor or accelerator), and to high-speed expansion ports 2010, which may accept various expansion cards (not shown). In the implementation, low-speed controller 2012 is coupled to storage device 2006 and low-speed expansion port 2014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 2000 may be implemented in a number of different forms, as shown in the figure. For example, it may be implemented as a standard server 2020, or multiple times in a group of such servers. It may also be implemented as part of a rack server system 2024. In addition, it may be implemented in a personal computer such as a laptop computer 2022. Alternatively, components from computing device 2000 may be combined with other components in a mobile device (not shown), such as device 2050. Each of such devices may contain one or more of computing device 2000, 2050, and an entire system may be made up of multiple computing devices 2000, 2050 communicating with each other.

Computing device 2050 includes a processor 2052, memory 2064, an input/output device such as a display 2054, a communication interface 2066, and a transceiver 2068, among other components. The device 2050 may also be provided with a storage device, such as a microdrive or other device, to provide additional storage. Each of the components 2050, 2052, 2064, 2054, 2066, and 2068, are interconnected using various buses, and several of the components may be mounted on a common motherboard or in other manners as appropriate.

The processor 2052 can execute instructions within the computing device 2050, including instructions stored in the memory 2064. The processor may be implemented as a chipset of chips that include separate and multiple analog and digital processors. Additionally, the processor may be implemented using any of a number of architectures. For example, the processor may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 2050, such as control of user interfaces, applications run by device 2050, and wireless communication by device 2050.

Processor 2052 may communicate with a user through control interface 2058 and display interface 2056 coupled to a display 2054. The display 2054 may be, for example, a TFT (Thin-Film-Transistor Liquid Crystal Display) display or an OLED (Organic Light Emitting Diode) display, or other appropriate display technology. The display interface 2056 may comprise appropriate circuitry for driving the display 2054 to present graphical and other information to a user. The control interface 2058 may receive commands from a user and convert them for submission to the processor 2052. In addition, an external interface 2062 may be provide in communication with processor 2052, so as to enable near area communication of device 2050 with other devices. External interface 2062 may provided, for example, for wired communication in some implementations, or for wireless communication in other implementations, and multiple interfaces may also be used.

The memory 2064 stores information within the computing device 2050. The memory 2064 can be implemented as one or more of a computer-readable medium or media, a volatile memory unit or units, or a non-volatile memory unit or units. Expansion memory 2074 may also be provided and connected to device 2050 through expansion interface 2072, which may include, for example, a SIMM (Single In Line Memory Module) card interface. Such expansion memory 2074 may provide extra storage space for device 2050, or may also store applications or other information for device 2050. Specifically, expansion memory 2074 may include instructions to carry out or supplement the processes described above, and may include secure information also. Thus, for example, expansion memory 2074 may be provide as a security module for device 2050, and may be programmed with instructions that permit secure use of device 2050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 2064, expansion memory 2074, or memory on processor 2052 that may be received, for example, over transceiver 2068 or external interface 2062.

Device 2050 may communicate wirelessly through communication interface 2066, which may include digital signal processing circuitry where necessary. Communication interface 2066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 2068. In addition, short-range communication may occur, such as using a Bluetooth, WiFi, or other such transceiver (not shown). In addition, GPS (Global Positioning System) receiver module 2070 may provide additional navigation- and location-related wireless data to device 2050, which may be used as appropriate by applications running on device 2050.

Device 2050 may also communicate audibly using audio codec 2060, which may receive spoken information from a user and convert it to usable digital information. Audio codec 2060 may likewise generate audible sound for a user, such as through a speaker, e.g., in a handset of device 2050. Such sound may include sound from voice telephone calls, may include recorded sound (e.g., voice messages, music files, etc.) and may also include sound generated by applications operating on device 2050.

The computing device 2050 may be implemented in a number of different forms, as shown in the figure. For example, it may be implemented as a cellular telephone 2080. It may also be implemented as part of a smartphone 2082, personal digital assistant, or other similar mobile device.

Additionally computing device 2000 or 2050 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method for permitting audience control over a sporting event, comprising:
receiving, by a first computing system and as having been sent by a second computing system, indications of multiple actions that a user of the second computing system specified as being candidates for performance by a team that is participating in a sporting event;
sending, by the first computing system and for receipt by multiple computing devices, information that identifies the multiple actions, so as to cause the multiple computing devices to present, to users of the multiple computing devices, the multiple actions as candidates for performance by the team;
receiving, by the first computing system and from each of at least a subset of the multiple computing devices, an indication of one of the multiple actions that a user of the respective computing device selected, from among the multiple actions, as being an action that the user of the respective computing device selects for performance by the team;
identifying, by the first computing system, a particular one of the multiple actions that received a greatest level of selections by the users of the at least subset of the multiple computing devices; and
sending, by the first computing system and for receipt by the second computing system, an indication of the particular one of the multiple actions, so as to cause the team to be prompted to perform the particular one of the multiple actions.

2. The computer-implemented method of claim 1, wherein:
multiple members of the team athletically participate in the sporting event, and
at least some of the users of the at least subset of the multiple computing devices are not located at a venue at which the members of the team are participating in the sporting event, and instead are watching the sporting event through a television broadcast or an internet broadcast.

3. The computer-implemented method of claim 2, wherein the user of the second computing system is a coach of the team or another individual that is affiliated with the team and that is located at the venue during performance of the sporting event.

4. A computer-implemented method, comprising:
receiving, by a computing device and as having been sent from a remote computing system, indications of multiple actions that have been specified as candidates for performance by a team that is participating in a sporting event;
concurrently displaying, by the computing device, multiple user interface elements that respectively identify the multiple actions that have been specified as candidates for performance by the team;
receiving, by the computing device, selection by a user of the computing device of one of the multiple user interface elements, the one of the multiple user interface elements identifying one of the multiple actions; and
sending, by the computing device and for receipt by the remote computing system, an indication that the user selected the one of the multiple actions, so as to cause the computing system to determine which one of the multiple actions received a greatest level of selections by the user and other users of other computing devices to which the multiple actions were also displayed for selection.

5. The computer-implemented method of claim 4, wherein the user of the computing device is viewing the sporting event or listening to the sporting event in person or through a television broadcast, a radio broadcast, or an internet broadcast.

6. The computer-implemented method of claim 4, wherein an individual that is employed by management of the team and that is at a venue at which the sporting is being performed specified the multiple actions.

7. The computer-implemented method of claim 4, wherein sending the indication that the user selected the one of the multiple actions further results in the computing system providing information that prompts the team to perform the one of the multiple actions that received the greatest level of selections by the user and the other users.

8. The computer-implemented method of claim 4, further comprising presenting, by the computing device, an indication of a time limit during which selection of the multiple user interface elements is available, selection of the multiple user interface elements being unavailable after expiration of the time limit.

9. The computer-implemented method of claim 4, wherein the computing device is configured to permit selection by the user of a single one of the multiple user interface elements, to the exclusion of selection by the user of more than one of the multiple user interface elements, in response to the concurrent display of the multiple user interface elements.

10. The computer-implemented method of claim 4, further comprising displaying, by the computing device and concurrent with the concurrent display of the multiple user interface elements, a current score of each team that is participating in the sporting event.

11. The computer-implemented method of claim 10, further comprising displaying, by the computing device and concurrent with the concurrent display of the multiple user interface elements, a time remaining until completion of the sporting event or a portion of the sporting event.

12. The computer-implemented method of claim 4, further comprising:
identifying, by the computing device, that the user of the computing device is able to specify a plurality of actions that will be displayed for selection to the other users of the other computing devices;
displaying, by the computing device, a plurality of user interface elements that identify a plurality of actions that the team is able to perform during the sporting event;
receiving, by the computing device, selection by the user of a subset of the plurality of user interface elements that identify a subset of the plurality of actions that the user has specified as being a second set of candidate actions for performance by the team; and
sending, by the computing device and for receipt by the computing system, indications of the second set of candidate actions, so as to cause the computing system to provide the second set of candidate actions for selection by each of the other users.

13. A computer-implemented method, comprising:
displaying, by a computing device, a plurality of user interface elements that identify a plurality of actions that a team is able to be performed during a sporting event;
receiving, by the computing device, selection by a user of the computing device of a subset of the plurality of graphical user interface elements so as to identify a subset of the plurality of actions that the user has specified as being candidates for performance by the team during the sporting event;
sending, by the computing device and for receipt by a computing system, indications of the subset of the plurality of actions, so as to cause the computing system to request that multiple other users each select at least one of the actions in the subset of actions for performance by the team;
receiving, by the computing device and as having been sent by the computing system, an indication of a particular one of the multiple actions that received a greatest level of selections by the multiple other users; and
causing, by the computing device, a prompt that the team perform the highest-voted one of the multiple actions.

14. The computer-implemented method of claim 13, wherein:
the plurality of graphical user interface elements are displayed concurrently; and
receiving the selection by the user of the subset of the plurality of the graphical user interface elements includes identifying that the user contacted portions of a touchscreen at which each of the plurality of graphical user interface elements was displayed.

15. The computer-implemented method of claim 13, further comprising receiving, by the computing device, an indication that the user selected one of the actions in the subset of the plurality of actions as a default action, wherein the computing device is configured to prompt the team to perform the default action in response to multiple of the actions in the subset of actions being selected a same amount by the multiple other users or in response to multiple of the actions in the subset of actions being selected a quantity of times that is beneath a threshold level of selections.

16. The computer-implemented method of claim 13, wherein causing the prompt that the team perform the highest-voted one of the multiple actions includes displaying, by the computing device, a graphical user interface element that identifies the particular one of the multiple actions as being the one of the multiple actions that received a greatest level of selections.
